(19) United States
(12) Patent Application Publication
(10) Pub. No.: US 2007/0152616 A1
(43) Pub. Date: Jul. 5, 2007

(54) Robot system and method for cathode selection and handling procedures after the harvest

(76) Inventor: Hugo Salamanca, Santiago (CL)

Correspondence Address: Hugo Salamanca P., Av. Suecia 84, Oficina 43, Providencia, Santiago, CL

(21) Appl. No.: 11/598,120

(22) Filed: Nov. 13, 2006

Related U.S. Application Data
(60) Provisional application No. 60/734,981, filed on Nov. 10, 2005.

(51) Int. Cl. G05B 19/19

(52) U.S. Cl. 318/568.11

(57) ABSTRACT

As a final stage of the current copper production process, the cathodes are inspected and sampled to determine its quality. Based on the inspection and the sampling the cathodes are selected and arranged according to the different qualities. Currently the inspection and selection of the cathodes in the loading site is carried out manually, which means that the operators must inspect and manipulate one by one the cathodes produced by the plant which requires a high physical effort and a great amount of labor force. Due to the above, a robot system and method have been developed for the selection and manipulation of cathodes in the site. The robotic system is composed mainly of a robotic manipulator of at least 5 degrees of freedom, and a gripping mechanism which allows to take the cathodes from a feeding system located at one of its sides and take it through a predefined path arranging them in groups according to their quality, the decision as to which quality group each cathode goes is taken by a superior order which could be automatic or manual. The system additionally has different racks in which the robotic system groups the cathodes according to the quality. In this regard, most of the problems associated to the current operation are eliminated

### CROSS-REFERENCE TO RELATED APPLICATIONS

This application claims the benefit of provisional patent application Ser. No. 60/734,981 filed 2005 Nov. 10 by the present inventor

### FEDERAL SPONSORED RESEARCH

Not Applicable

### SEQUENCE LISTING OR PROGRAM

Not Applicable

### BACKGROUND—FIELD OF INVENTION

This invention relates to the use of robotic technology in mining industry, specifically in repetitive and physically demanding tasks.

### BACKGROUND—PRIOR ART

The electrodeposition process is one of the current and simplest methods to recover, in a pure and selective way, the metals in a solution. This process mainly uses the permanent cathode technology, which consists in depositing the metal directly on the same mother blanks through an electrochemical process. This process is carried out in electrolytic cells until reaching the adequate weight for them to be removed and sent to the cathode stripping system. The most frequently used substrate in these cathodes if 316L stainless steel.

This technology uses different stripping machines. The most common are the following:
ISA Process, which is characterized by using a wax in the lower edge of the cathode to control the lower deposit, generating two metal plates and the stripping system is linear and U shaped.
Kidd Process (carousel), which is a variant machine very similar to the above, but it is a wax less technology which generates a blank joined with the two faces of the metal deposit and it uses a stripping system as a wheel with different work stations.

The cathodes obtained as final product of the process have different quality levels due to the presence of several contaminants (lead and chloride among others) which lessens the purity of the cathode harvested. Due to this effect all the cathodes obtained in the electrodeposition process should be inspected and selected according to the quality. Currently this procedure is carried out manually.

The task of inspecting and selecting the cathodes manually has some disadvantages such as:
High physical demand from the operators due to the fact they have to manipulate loads weighing 50 kg during all the working day.
High operating costs due to the high number of people involved in the activity.
Low quality control of selection due to the fact there are no objective parameter to define the different qualities of the cathodes.

### SUMMARY

A robot system and method have been developed for the selection and handling processes of cathodes after the harvest. The manipulator takes the cathodes from a feeding belt and moves it to different storing points depending on its quality.

### DRAWINGS—FIGURES

FIG. 1. General view of a robot system for the selection and handling of cathodes after the harvest.

FIG. 2. View of the layout of a robot system for the selection and handling of cathodes after the harvest

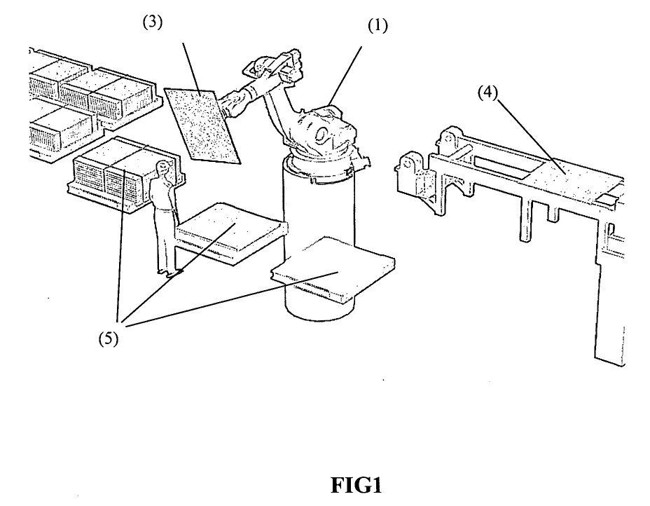

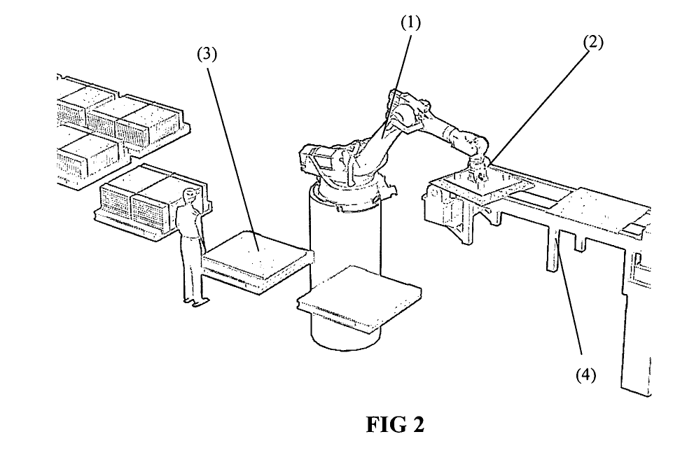

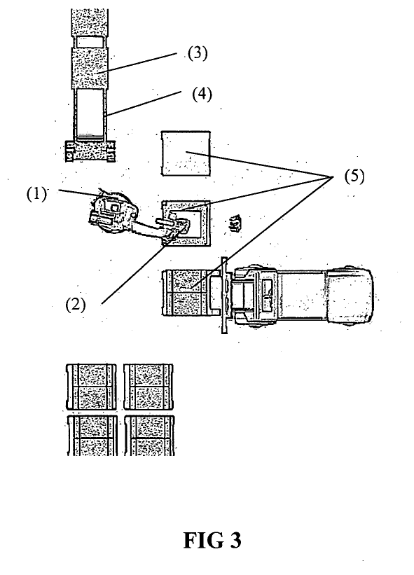

### DRAWINGS—REFERENCE NUMERALS

1. Robotic manipulator

2. Gripping mechanism

3. Cathodes

4. Feeding system

5. Racks

### DETAILED DESCRIPTION

This invention relates to a new robot system as well as a robotic method for the selection and handling of cathodes after the harvest which is carried out automatically the selection and manipulation of the cathodes according to a higher order which could be manual or automatic, through anthropomorphous robotic arms of at least 5 degrees of freedom. The number of robotic manipulators which are used in the selection will depend on the number of cathodes processed.

With reference to FIGS. No1, 2 and 3, the robot system for the selection and handling is composed mainly of one anthropomorphous robotic manipulator of at least 5 degrees of freedom (1), provided with a communication, acquisition and control system, and a gripping mechanism (2) which allows in a sequential and programmed way to take, manipulate and release cathodes (3) from a feeding system (4), located at one of its sides, and move it through a defined path, in order to arrange them in groups according to their quality, so as the decision as to which quality group the cathode goes is taken by a higher order which could be automatic or manual. The system additionally has different racks in which the system groups the cathodes according to the quality (5).

I claim

1. A robot system for the selection and handling of cathodes after the harvest comprising an anthropomorphous robotic arm of at least 5 degrees of freedom, one control, communication and programming unit, one gripper adapter, one pneumatic gripper, its fingers, one pneumatic gripper driving system, one electric supply system wherein the anthropomorphous robotic arm of at least 5 degrees of freedom is provided with a pneumatic gripping mechanism which allows in a sequential and programmed way to take, manipulate and release the cathodes from a feeding belt and move them through a predefined path to the different storing points.

2. A robot system for the selection and handling of cathodes after the harvest according to claim 1, wherein the anthropomorphous robotic manipulator could communicate by itself or through a PLC interface with the control system.

3. A robot system for the selection and handling of cathodes after the harvest according to claim 1, wherein the anthropomorphous robotic manipulator has the capacity to obtain and interpret the information from installed analogue and/or digital sensors.

4. A robot system for the selection and handling of cathodes after the harvest according to claim 1, wherein the anthropomorphous robotic manipulator has the capacity to generate analogue and/or digital signals to control analogue and/or digital input devices.

5. A robot system for the selection and handling of cathodes after the harvest according to claim 1, wherein a pneumatic gripping mechanism is used which allows to take, manipulate and release the cathodes.

6. A robot system for the selection and handling of cathodes after the harvest according to claim 1, wherein the anthropomorphous robotic manipulator has an electrical system driven by three-stage induction motors, with vectorial and/or scalar control.

7. A robot system for the selection and handling of cathodes after the harvest, according to claim 1, wherein it has the capacity to move and manipulate copper sheets or cathodes in different paths within the work volume of the robotic system.

8. A robot system for the selection and handling of cathodes after the harvest according to claim 1, wherein it could be integrated to an automatic or manual inspection system which indicates the quality of the cathode for it to execute the selection.

9. A robot system for the selection and handling of cathodes after the harvest according to claim 1, wherein it could be integrated to any process with a sheet as final product as it is the copper sheet.

10. A robot system for the selection and handling of cathodes after the harvest according to claim 1, wherein productivity and efficiency of the selection and handling of cathodes after the harvest in electrometallurgical processes of different metals such as copper, nickel, zinc, etc. increases.

11. A robot system for the selection and handling of cathodes after the harvest according to claim 1, wherein the system may operate automatically, or semi-automatically, and also allows solutions scalability.

12. A robot system for the selection and handling of cathodes after the harvest according to claim 1, wherein it prevents the plant personnel from being subjected to a high physical demand and harsh environmental conditions.

13. A robotic method for the selection and handling of cathodes after the harvest using the robot System of claim 1 to 12, wherein the anthropomorphous robotic arm of at least 5 degrees of freedom is provided with a pneumatic gripping mechanism which allows in a sequential and programmed way to take, manipulate and release the cathodes from a feeding belt and move them through a predefined path to the different storing points.

14. A robotic method for the selection and handling of cathodes after the harvest using the robot System of claim 1 to 12, wherein a pneumatic gripping mechanism is used which allows taking, manipulating and releasing the cathodes.

15. A robotic method for the selection and handling of cathodes after the harvest using the robot System of claim 1 to 12, wherein the anthropomorphous robotic manipulator could communicate by itself or through a PLC interface with the control system.

16. A robotic method for the selection and handling of cathodes after the harvest using the robot System of claim 1 to 12, wherein the anthropomorphous robotic manipulator has the capacity to obtain and interpret the information from installed analogue and/or digital sensors.

17. A robotic method for the selection and handling of cathodes after the harvest using the robot System of claim 1 to 12, wherein the anthropomorphous robotic manipulator has the capacity to generate analogue and/or digital signals to control the analogue and/or digital inputs devices.

18. A robotic method for the selection and handling of cathodes after the harvest using the robot System of claim 1 to 12, wherein the anthropomorphous robotic manipulator has an electrical system driven by three-stage induction motors with vectorial and/or scalar control.

19. A robotic method for the selection and handling of cathodes after the harvest using the robot System of claim 1 to 12, wherein it has the capacity to move and manipulate copper sheets or cathodes in different paths within the work volume of the robotic system.

20. A robotic method for the selection and handling of cathodes after the harvest using the robot System of claim 1 to 12, wherein it could be integrated to an automatic or manual inspection system which indicates the quality of the cathode for it to execute the selection.

21. A robotic method for the selection and handling of cathodes after the harvest using the robot System of claim 1 to 12, wherein it could be integrated to any process with a sheet as final product as it is the copper sheet.

22. A robotic method for the selection and handling of cathodes after the harvest using the robot System of claim 1 to 12, wherein productivity and efficiency of the selection and handling of cathodes after the harvest in electrometallurgical processes of different metals such as copper, nickel, zinc, etc. increases.

23. A robotic method for the selection and handling of cathodes after the harvest using the robot System of claim 1 to 12, wherein the system may operate automatically or semi-automatically, and also allows solution scalability.

24. A robotic method for the selection and handling of cathodes after the harvest using the robot System of claim 1 to 12, wherein it prevents the plant personnel from being subjected to a high physical demand and harsh environmental conditions.
